(19) United States
(12) Patent Application Publication
(10) Pub. No.: US 2025/0343711 A1
(43) Pub. Date: Nov. 6, 2025

(54) SERDES QUICK WAKE AND COMMUNICATION LOCK

(71) Applicant: Analog Devices, Inc., Wilmington, MA (US)

(72) Inventors: Mark Alexander DIVITO, Wilmington, MA (US); Thomas J. HOUCK, Wilmington, MA (US)

(21) Appl. No.: 19/194,843

(22) Filed: Apr. 30, 2025

Related U.S. Application Data
(60) Provisional application No. 63/641,332, filed on May 1, 2024.

(51) Int. Cl. H04L 25/03

(52) U.S. Cl. CPC H04L 25/03019

(57) ABSTRACT

Examples of technology disclosed herein determine, by a serializer and a deserializer, one or more of calibration parameters and adaptive equalization (AEQ) parameters to perform calibration and AEQ for a communication link between the serializer and the deserializer. Such examples store the one or more parameters into a retention memory, and then put at least one of the serializer and deserializer into a sleep/low power mode. Upon receiving a wakeup command at each of the serializer and the deserializer put into the sleep mode, the serializer and the deserializer perform link lock of the communication link using the stored parameters.

### CROSS-REFERENCE TO RELATED APPLICATIONS

This application claims the benefit of and priority to U.S. Provisional Application No. 63/641,332, filed May 1, 2024, and titled “SERDES QUICK WAKE AND COMMUNICATION LOCK”, the entire contents of which are hereby incorporated by reference.

### TECHNICAL FIELD

Aspects disclosed herein relate to serializer/deserializer (SERDES) I2C auto configuration, and more specifically to systems and methods for low power and fast link lock for SERDES link.

### BACKGROUND

Gigabit Multimedia Serial Link (GMSL) is a serial link technology that is used for multimedia distribution in various applications, such as In-Vehicle Infotainment (IVI) systems and Advanced driver-assistance systems (ADAS) in vehicles. Inter-Integrated Circuit (I2C) auto configuration is used when GMSL serializer/deserializer (SERDES) powers up from a complete power down state and needs an ability rapidly communicate with other devices, for example, to immediately start video data transmission. For power savings, a GMSL SERDES may be put into a low power state when the SERDES is not active.

### SUMMARY

Disclosed herein are systems and methods describing various aspects of SERDES power up operations.

In some aspects, the techniques described herein relate to methods for managing serial communication between a serializer and a deserializer, including: determining, by the serializer and the deserializer, one or more of (i) one or more calibration parameters and (ii) one or more adaptive equalization (AEQ) parameters to perform at least one of calibration and AEQ for a communication link between the serializer and the deserializer; storing the one or more parameters into a retention memory; putting at least one of the serializer and deserializer into a sleep mode; and upon receiving a wakeup command at each of the serializer and the deserializer put into the sleep mode, performing, by the serializer and the deserializer, link lock of the communication link using the stored one or more parameters.

In some aspects, the techniques described herein relate to a method, wherein the determining, the storing, and the putting into a sleep mode are periodically performed by temporarily waking up each sleeping serializer and sleeping deserializer from a sleep mode for each of the determining, the storing, and the putting into a sleep mode.

In some aspects, the techniques described herein relate to a system for managing serial communication, including: a serializer including at least one processor; a deserializer including at least one processor; a communication link connecting the serializer and deserializer; retention memory; and program memory including instructions that when executed by processors of the system are operative to cause the system to: determine, for each of the serializer and the deserializer, one or more of (i) one or more calibration parameters and (ii) one or more adaptive equalization (AEQ) parameters to perform at least one of calibration and AEQ for the communication link; store the one or more parameters into the retention memory; put at least one of the serializer and deserializer into a sleep mode; and upon receiving a wakeup command at each of the serializer and the deserializer put into the sleep mode, performing, by the serializer and the deserializer, link lock of the communication link using the stored one or more parameters.

In some aspects, the techniques described herein relate to a system, wherein the determining, the storing, and the putting into a sleep mode are periodically performed by temporarily waking up each sleeping serializer and sleeping deserializer from a sleep mode for each of the determining, the storing, and the putting into a sleep mode.

### BRIEF DESCRIPTION OF THE DRAWINGS

Further details, features and advantages of the various aspects emerge from the following description of preferred aspects with reference to the drawing.

FIG. 1 depicts an overview of a serial link between deserializer and a serializer that is woken using a host processor, according to one or more aspects of the technology disclosed herein.

FIG. 2 depicts various ways for a serializer/deserializer to be woken, according to one or more aspects of the technology disclosed herein.

FIG. 3 depicts various waves for transitions to wake up a serializer from a sleep mode, according to one or more aspects of the technology disclosed herein.

FIG. 4A depicts a first portion of a typical wakeup and link lock process of a serializer and a deserializer, according to one or more aspects of the technology disclosed herein.

FIG. 4B depicts a second portion of the typical wakeup and link lock process of a serializer and a deserializer, according to one or more aspects of the technology disclosed herein.

FIG. 5A depicts a first portion of a wakeup process of a serializer and a deserializer for periodic calibration, according to one or more aspects of the technology disclosed herein.

FIG. 5B depicts a second portion of the wakeup process of a serializer and a deserializer for periodic calibration, according to one or more aspects of the technology disclosed herein.

FIG. 6 depicts a final wake of a serializer and a deserializer for video transmission, according to one or more aspects of the technology disclosed herein.

FIG. 7 is a flow diagram illustrating methods for managing serial communication between a serializer and a deserializer, according to one or more aspects of the technology disclosed herein.

### DETAILED DESCRIPTION

In the following description, for the purposes of explanation, specific details are set forth in order to provide an understanding of the various aspects. It will be apparent, however, to one skilled in the art that the aspects disclosed herein can be practiced without these details. One skilled in the art will recognize that the various aspects described below may be performed in a variety of ways and using a variety of means. Those skilled in the art will also recognize additional modifications, applications, and aspects are within the scope thereof, as are additional fields in which the aspects may provide utility. Accordingly, the aspects described below are illustrative aspects.

A reference in the specification to “one aspect” or “an aspect” means that a particular feature, structure, characteristic, or function described in connection with the aspect is included in at least one aspect. The appearance of the phrase “in one aspect,” “in an aspect,” or the like in various places in the specification are not necessarily all referring to the same aspect.

Connections illustrated in the figures between components may be modified or otherwise changed through the addition thereto of intermediary components, without departing from the teachings of the present disclosure. Furthermore, one skilled in the art shall recognize: (1) that certain steps may optionally be performed; (2) that steps may not be limited to the specific order set forth herein; and (3) that certain steps may be performed in different orders, including being done contemporaneously.

Modern electric vehicles are powered by one or more batteries from which their various systems are able to perform various operations, including driving, self-driving, navigation, lighting, in-vehicle infotainment, and surveillance. Surveillance activities, which can be employed in a mode sometimes referred to as Sentry Mode, can be engaged or otherwise in an on state when an electric vehicle is parked, and other systems are in a sleep or powered down state. Alternatively or additionally, safety concerns such as when reversing using a backup camera can be briefly engaged when a vehicle is shifted into reverse. In various aspects, when a vehicle such as an electric vehicle includes one or more cameras, microphones, and/or sensors (e.g., proximity sensor(s), radar, LiDAR), these cameras and/or sensors may be used to record events occurring near the vehicle. Examples of these events include people or objects moving near the vehicle, which may impact the vehicle such as a person attempting to gain access to an interior of the vehicle or an object about to physically touch the vehicle as in the case of a car crash or object striking the vehicle. These types of events may occur rapidly (e.g., on the order of fractions of a second) and typical SERDES startup procedures may be too lengthy (e.g., from 60 to 70 milliseconds (ms) or even 100 ms) to effectively capture a record immediately prior to or at the time the event occurs. These records can be used for insurance claim purposes, among others. Cameras and sensors (e.g., proximity sensors) can draw power from the battery and both speed of operation and battery conservation can be beneficial considerations for maintaining desired operation.

Other implementations are also contemplated, including manufacturing, industrial, robotics, consumer applications, and/or other SERDES quick link lock applications that include audio, video, and/or proximity sensors.

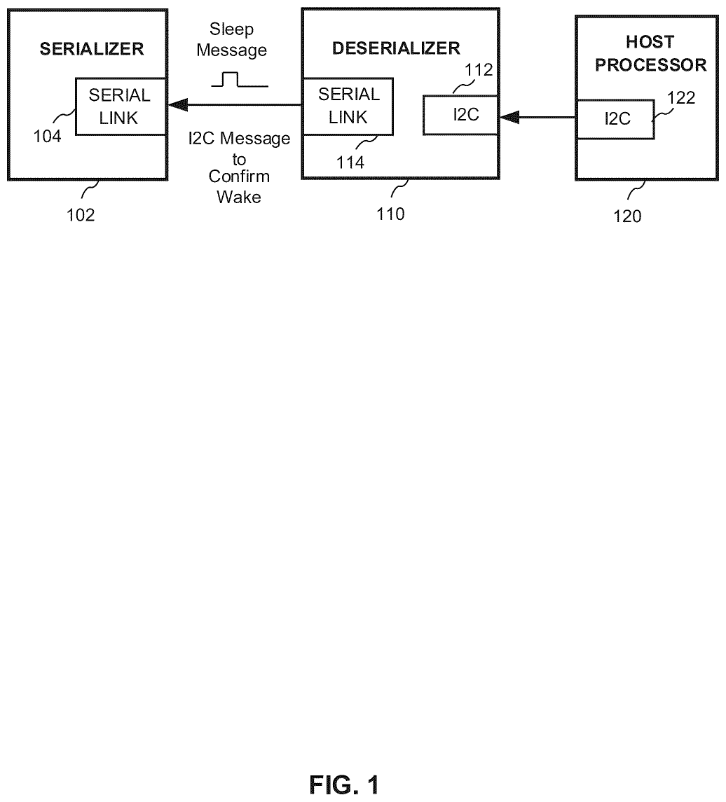

FIG. 1 depicts an overview of a serial link between deserializer 110 and a serializer 102 that is woken using a host processor 120, according to one or more aspects. The host processor 120 sends an I2C message to a deserializer 110 via an I2C link coupled between a host I2C interface 122 and a deserializer I2C interface 112. The deserializer 110 then sends the I2C message to a serializer 102 via a serial link coupled between a serial interface 114 within the deserializer 110 and a serial interface 104 within the serializer 102. The serial link may be a GMSL, GMSL-2, or GMSL-3 link that supports multimedia serial communication for various applications, such as in-vehicle infotainment (IVI), autonomous driving, etc. In various aspects, a serial link initiation between the deserializer 110 and serializer 102 is known as a handshake.

The serializer 102 may be a camera module or component thereof deployed on a vehicle for video image capturing. The I2C message may be used to put the serializer 102 into a low-power mode or a sleep mode for power savings, which is especially important for electric vehicles (EVs). Alternatively, the I2C message may be used to wake up serializer 102 such that the serializer 102 may immediately or promptly transmit data such as video images. It is desired that the time delay of image data transmission after receiving the wakeup message be minimized, especially when crucial safety or liability information, typically in the beginning of captured data, is involved. Various aspects described herein allow for minimization of the time delay of image data transmission after receiving the wakeup message while maintaining signal integrity and/or quality of the captured data.

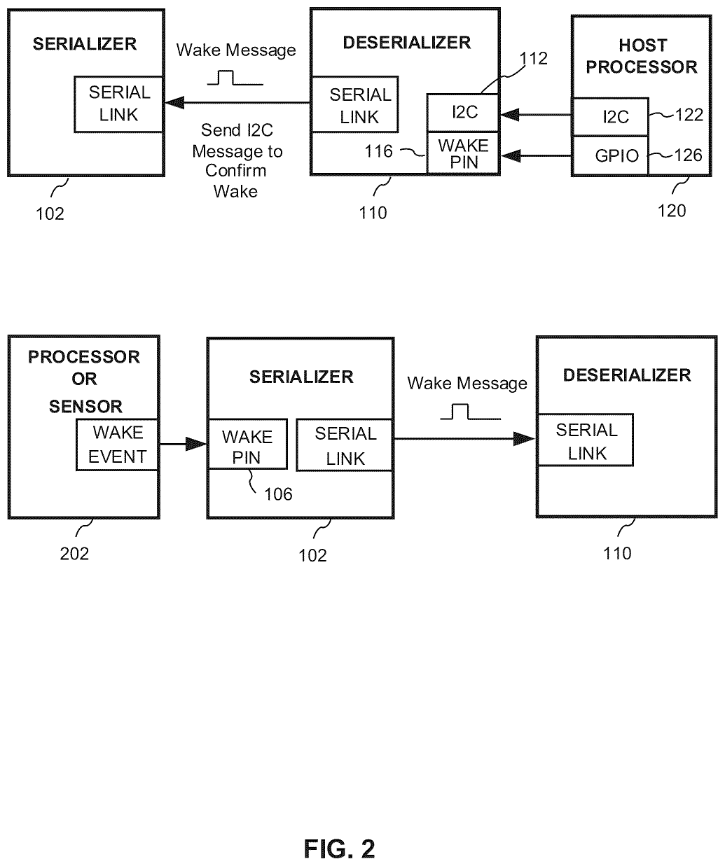

FIG. 2 depicts various ways for a serializer/deserializer to be woken according to one or more aspects. In an initial state, the serializer 102 and the deserializer 110 can be in a low power state (e.g., a sleep mode) and external power can be constantly and/or intermittently provided. The deserializer 110 may be woken by the host processor 120, which sends a wake message from a GPIO pin 126 to a designated wake pin 116 in the deserializer 110. The deserializer 110 then sends the wake message via a serial link to the serializer 102. In some aspects when the host processor 120 puts the deserializer 110 into a sleep mode, this can be a command sent from I2C interface 122 of host processor 120 to I2C interface 112 of deserializer 110.

Alternatively, the serializer 102 may be woken first by a separate processor or sensor 202, which may send a wake message to a designated wake pin 106 in the serializer 102 when a wake event is triggered. For example, the sensor 202 may be a microphone configured to send a wake signal when the microphone detects a noise (e.g., a collision noise or explosion noise, or approaching exhaust or motor noise) above a threshold. Alternatively or additionally, the sensor 202 may be a radar and/or LiDAR sensor that senses that an object such as another vehicle is within a particular range and/or closing a distance to the vehicle. Alternatively or additionally, the sensor 202 may be a camera that detects movement (e.g., a vehicle or person approaching the vehicle) Upon receiving the wake signal from the sensor 202, the serializer 102 may then send a wake message via a serial link to the deserializer 110 to wake up the deserializer 110.

In some aspects, the deserializer 110 can include a clock and/or timer mechanism configured to run a counter. In some aspects, the serializer/deserializer and/or one or more sensors can have a shared power rail.

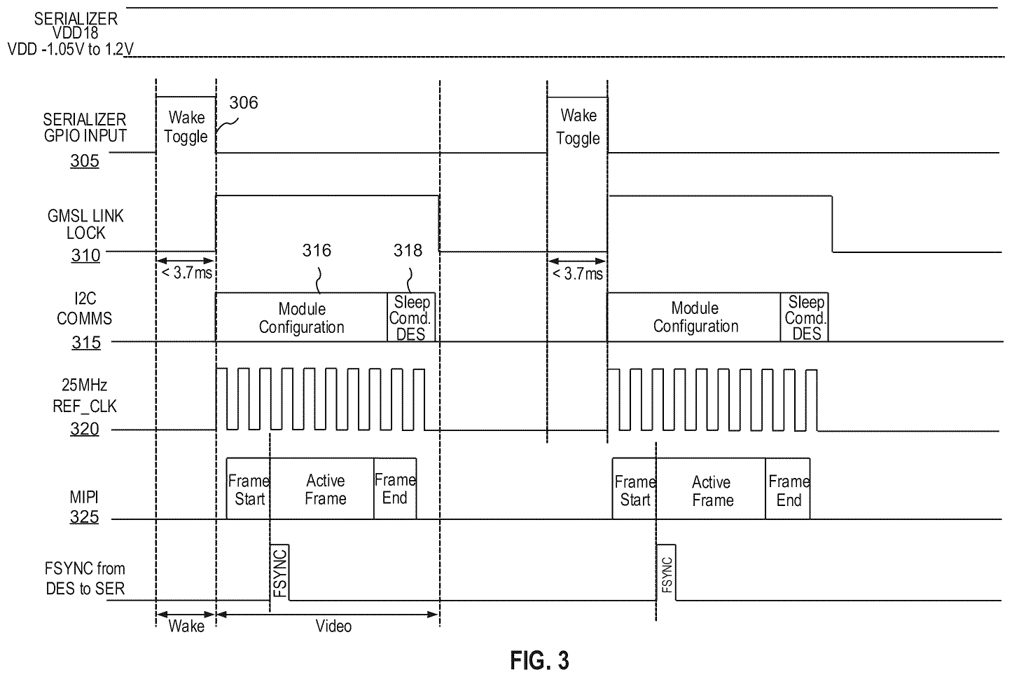

FIG. 3 depicts various waves for transitions to wake up a serializer from a sleep mode according to one or more aspects. A serializer GPIO input signal 305 may be an input to a GPIO pin to wake up the serializer. The input signal 305 comprises a wake toggle 306 for a quick lock (e.g., less than 3.7 ms as shown in FIG. 3) of the serial link between the serializer/deserializer for immediate video image transmission. Once locked, a GMSL link lock signal 310 is in a logic high state to indicate that the GMSL link is in a locked status during which video images are transmitted over the GMSL serial link.

An I2C command signal 315 may be transmitted from a host processor to the deserializer. The I2C command signal 315 comprises module configuration information 316 for deserialization operation and a sleep command 318 to put the GMSL serializer/deserializer into a sleep mode after the deserialization operation. A reference clock signal 320 may be communicated between the deserializer and host processor for operation synchronization.

In one or more aspects, the serializer 102 may receive video images, on a Mobile Industry Processor Interface (MIPI) Camera Serial Interface 2 (CSI-2) interface, as an MIPI signal 325 and outputs it on a serial interface 104, e.g., a GMSL serial link transceiver. Simultaneously, the serializer 102 may send and receive bidirectional control channel data across the same GMSL link. GMSL data can be transported over Coaxial or Shielded-Twisted Pair (STP) cables. In aspects involving vehicles such as automobiles, a cable length may be 15 meters or less between the serializer 102 and the deserializer 110. As noted above, the communications link may be a GMSL, GMSL-2, GMSL-3, or any such serial link that supports multimedia serial communication for various applications, such as in-vehicle infotainment (IVI), autonomous driving, etc.

Using a quick wakeup operation for a fast link lock, a serializer may be put into a sleep mode and quickly waken up after receiving a wake command from a deserializer. Such implementation allows for a low power SERDES link that may be advantageous for various applications (e.g., enabling a longer battery life for an EV).

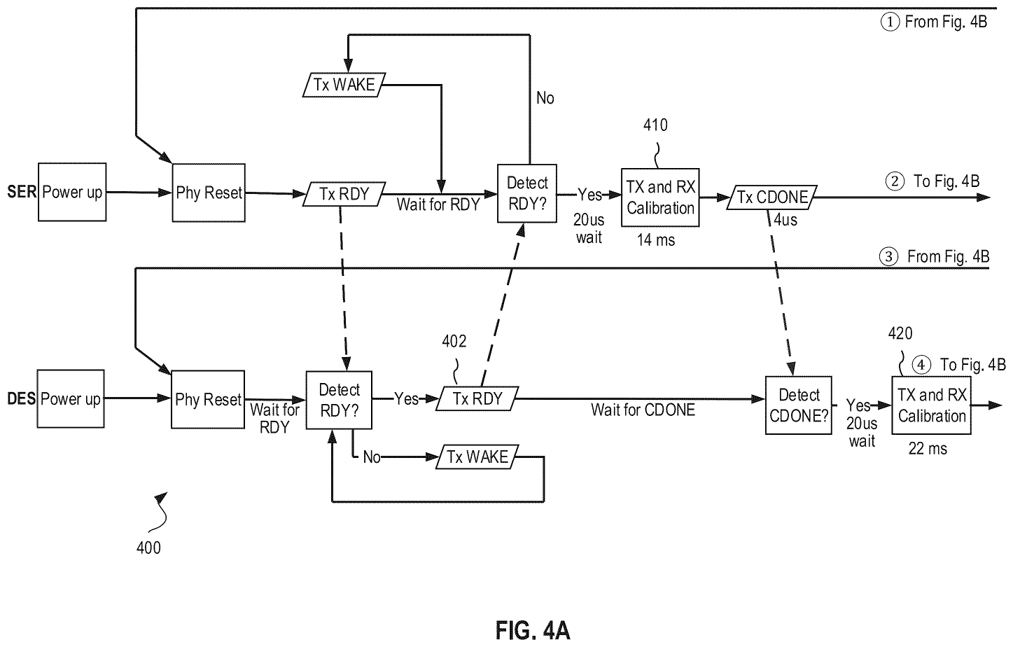

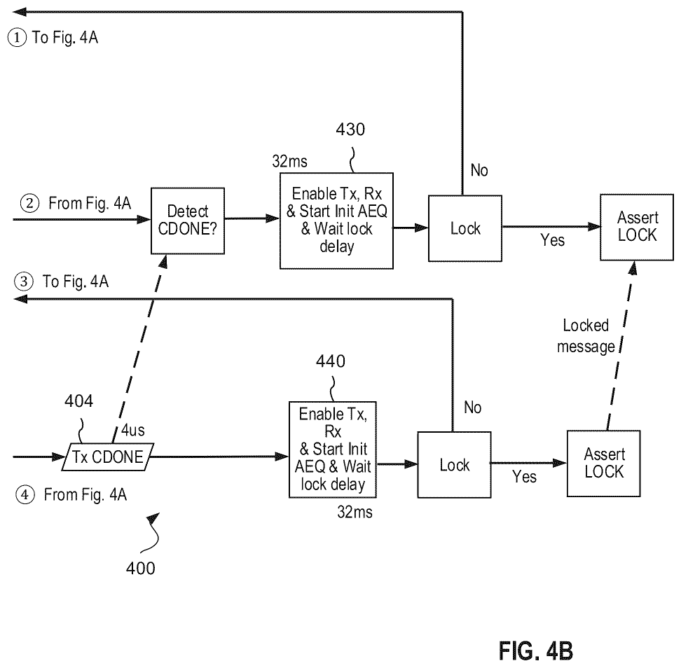

FIG. 4A and FIG. 4B depicts a typical wakeup and link lock process 400 of a serializer and a deserializer. Once a wake command is received, the serializer and the deserializer begin a wakeup and link lock process 400. Traditionally, such a wakeup process involves one or more calibration steps to determine one or more operation parameters for the serializer and the deserializer in a preparation for data (e.g., video images, audio data, and/or sensor data) transmission over the serial link between the serializer and the deserializer. Such calibration steps have traditionally been needed or required because the serial link has characteristics subject to ambient environment changes, especially temperature variations. Therefore, without proper calibration, data transmission may suffer serious noise, jitter, loss, mismatch, or other undesired impacts.

For power savings, a GMSL SERDES may be put into a low power state when the SERDES is not active. The SERDES may need to rapidly re-establish link lock and immediately start video data transmission following link lock. The capability to re-establish link lock promptly is challenging to achieve due to a relatively lengthy wakeup process involving various calibrations and parameter configurations. In certain situations, when a serial camera in a vehicle needs to be woken for video recording immediately in an emergency, a delay in link lock may miss some crucial information at the beginning of the emergency and thus bring serious challenges to address certain safety or liability related issues.

As shown in FIG. 4A and FIG. 4B, calibration steps comprise transmitter (Tx) and receiver (Rx) calibration 410 at the serializer, Tx/Rx calibration 420 at the deserializer, parameter calibration 430 for an adaptive equalizer (AEQ) at the serializer (e.g., enabling transmission, reception, and starting initialization of the AEQ and a wait lock delay), and parameter calibration 440 for a deserializer AEQ (e.g., enabling transmission, reception, and starting initialization of the AEQ and a wait lock delay). These calibrations may take multiple milliseconds and even require more than one round of calibration for parameter stabilization. In addition to performing all of these required calibrations, the wakeup process also comprises multiple calibration ready and confirmation communications, e.g., Tx ready (Tx RDY) 402 and calibration done (CDONE) 404, between the serializer and the deserializer. Performing all of these calibrations and associated confirmations lengthens the wakeup process and makes it difficult, or even impossible, for immediate or timely transmission of data such as video images after a wake command is received. The inevitable delay in traditional wakeup processes may bring serious safety concerns for certain applications, including a failure to record critical data corresponding to an event occurring while the lengthy wakeup process is occurring.

In some aspects, instead of performing full-length calibration including the various steps described above and shown in FIGS. 4A-4B after a wake command is received, periodic calibrations may be performed for the serial link between the serializer and the deserializer without involving and/or requiring a wake command. In some aspects, periodic calibrations can occur in less than one percent of the time required during the lengthy wakeup process including calibration. For example, a period can be about twenty seconds in some aspects, while the whole wakeup process without the lengthy calibration/recalibration process can be about five milliseconds and the resulting wakeup time can be about five milliseconds. Further, the state of the vehicle may not be taken into account in various aspects. While the serializer and the deserializer are in sleep modes, they are temporarily woken to perform periodic calibrations, and then put back into the sleep modes once the calibration is done. Parameters during a current calibration cycle are saved into a retention memory with parameters recorded during a previous calibration overwritten. Comparing to the periodic cycles (e.g., ˜second level), actual calibration takes much less time (e.g., ˜millisecond level,) and average power consumption can be trivial.

In the present disclosure, “retention memory” to be defined as memory that persists when the device corresponding to the parameters is placed in a sleep/low power mode. Examples include [1] non-volatile memory on the device corresponding to the parameters, [2] volatile memory that remains powered on the device corresponding to the parameters when the device is in sleep/low power mode, and [3] memory off the device corresponding to the parameters that persists when the device corresponding to the parameters when the device is in sleep/low power mode, e.g., a) storing serializer parameters on the deserializer, sleeping the serializer, waking up the serializer and sending the parameters, b) storing serializer parameters on the host processor, sleeping the serializer, waking up the serializer and sending the parameters from the host processor.

Accordingly, once a wake command is received (e.g., from a host processor and/or sensor), the serializer and the deserializer may use immediately parameters that were saved during a previous calibration for link lock in order to begin data (e.g., video image, audio, and/or sensor data) transmission, instead of engaging in a lengthy calibration process prior to data transmission. Given that periodic calibration operation(s) may be performed in a cycle of a relatively short period (e.g., a few seconds) environmental conditions during such a relatively short period are highly unlikely to change to an appreciable extent that would otherwise cause serious deviation of parameters for the serializer and the deserializer.

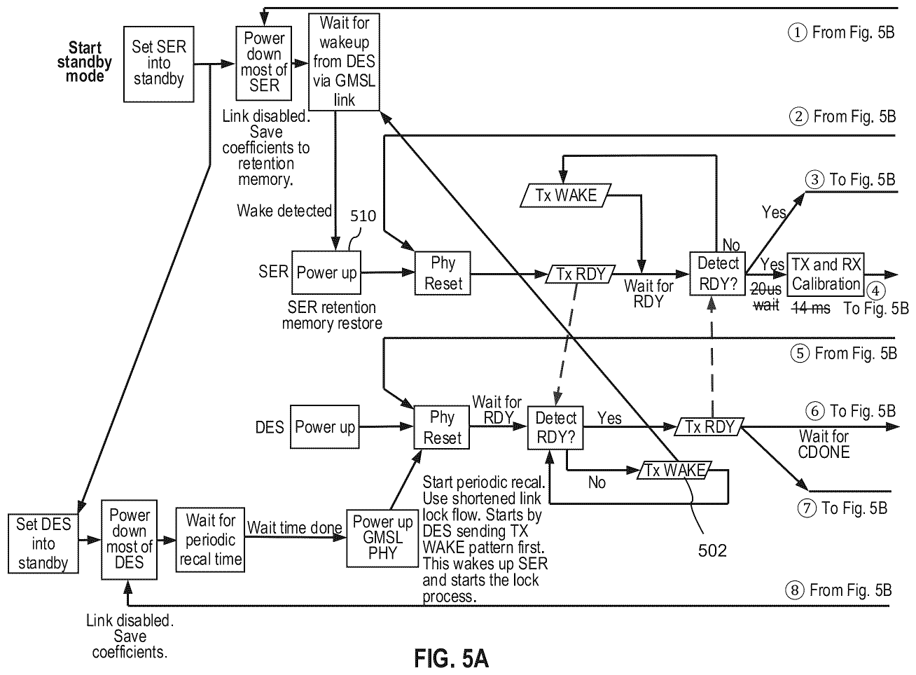

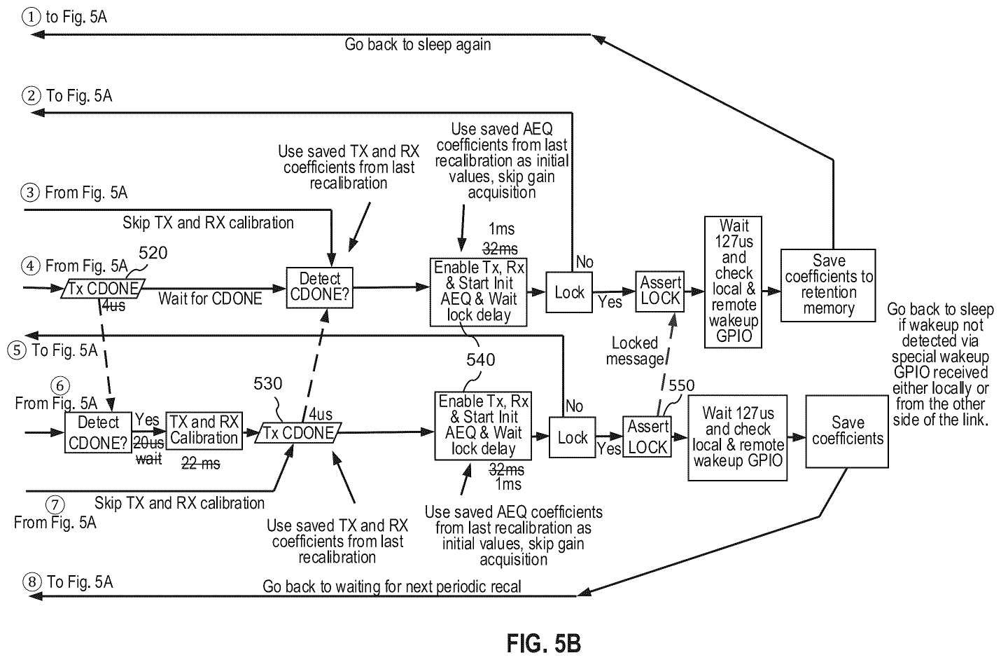

FIG. 5A and FIG. 5B depict a wakeup process of a serializer and a deserializer for periodic calibration according to one or more aspects. FIGS. 5A-5B show an abbreviated or quick wake process that provides an improvement over existing wake up/link lock processes by minimizing the time required before data can be transmitted over a link while maintaining signal integrity and/or quality of the captured data. These time savings are shown, for example, with lines through times that would otherwise be required in existing wake up/link lock processes (e.g., 20 ms, 14 ms, 4 us, 20 us, 22 ms that are lined through in FIGS. 5A-5B).

Once a wake command is transmitted at block 502 from a deserializer to a serializer via a GMSL serial link (e.g., when a sensor senses or detects activity such as an event to be recorded is occurring and/or when a timer threshold is reached), the serializer is powered up and accesses the retention memory to fetch or retrieve saved serializer parameters/coefficients from memory, as indicated in block 510. Accordingly, the serializer has kept stored parameters/coefficients fresh as the environment changes (e.g., lighting, weather conditions such as temperature and/or moisture, and/or other environmental changes). Examples of parameters/coefficients can include capacitance that is calibrated for the receiver(s) and/or one or more coefficients for the receiver(s) such as receiver gain or adaptation coefficient(s).

Because the saved serializer parameters/coefficients are retrieved from memory, the Tx/Rx calibration set of interactions between the serializer and deserializer is bypassed. As shown in FIG. 5A by the lined through 20 us (microsecond) and 14 ms, by-passing (i.e., skipping) the TX/RX calibration state allows for significant time savings just after the wakeup process. Thus, the parameters/coefficients can be saved in memory for future retrieval, and the next instance of the wake command occurring allows for these parameters/coefficients to be quickly retrieved. The serializer uses the stored parameters/coefficients to finish configuration of the serializer Tx directly and can also skip block 520, where a serializer Tx calibration done (CDONE) message would otherwise be sent to the deserializer.

Further time and energy savings occur at the deserializer, where otherwise, upon receiving the Tx CDONE from the serializer, the deserializer would need to perform deserializer Tx/Rx calibration. Instead, the deserializer uses saved deserializer Tx/Rx parameters to finish configuration of the deserializer Tx directly, and moves to block 530, where the deserializer sends a deserializer Tx CDONE message to the serializer. As shown in FIG. 5B by the lined through 20 us wait and 22 ms, bypassing (i.e., skipping) the TX/RX calibration operation allows for time savings in the wakeup process. The coefficients recalled from memory are thus used in the current round. Afterwards, the serializer and deserializer are each able to move to blocks 540 and enable Tx/Rx and start initial AEQ using saved AEQ coefficients as initial values. Accordingly, gain acquisition and delay are skipped for quick link adaptation. As stated above, the Tx/Rx calibration and AEQ delay can be also skipped because the coefficients are up to date due to the periodic recalibrations.

If saved parameters/coefficients are not good for a current link lock, the process goes back to step (2) and (5) for physical layer (PHY) reset and a new round of Tx/Rx and AEQ calibration for the serializer/deserializer (i.e., the link lock is started over). Such process goes on until updated parameters/coefficients are good enough for link lock. Examples of determinations of parameters/coefficients that are not good can include determinations that the receiver is unable to receive and/or interpret the data properly and will have one or more bit errors on the receiver side as determined by one or more detectors. This can trigger a new round of the Tx/Rx and/or AEQ calibration for the serializer/deserializer. Due to the bidirectional nature of the link, when the serializer stops sending data to the deserializer, the deserializer can detect this absence of data and trigger a new round of the Tx/Rx and AEQ calibration for the serializer/deserializer.

Otherwise, if the saved or updated parameters/coefficients are good for a current link lock, the deserializer sends a locked message at block 550 to the serializer for the link lock completion. After waiting for a predetermined time (˜millisecond level) without another wake command from the deserializer (via the serial link) or another processor/sensor (e.g., a host processor via a wakeup GPIO), the serializer goes back to the sleep mode with applicable updated parameters/coefficients saved into the retention memory.

In one or more aspects, the deserializer may wait for the same predetermined time as the serializer before going back to waiting for next periodic calibration cycle. In various aspects, control of powering up the link are located on one side of the link. In many aspects shown in the figures, the deserializer side of the link is chosen as the control side. Accordingly, parameters and/or coefficients are retained on the deserializer side of the link.

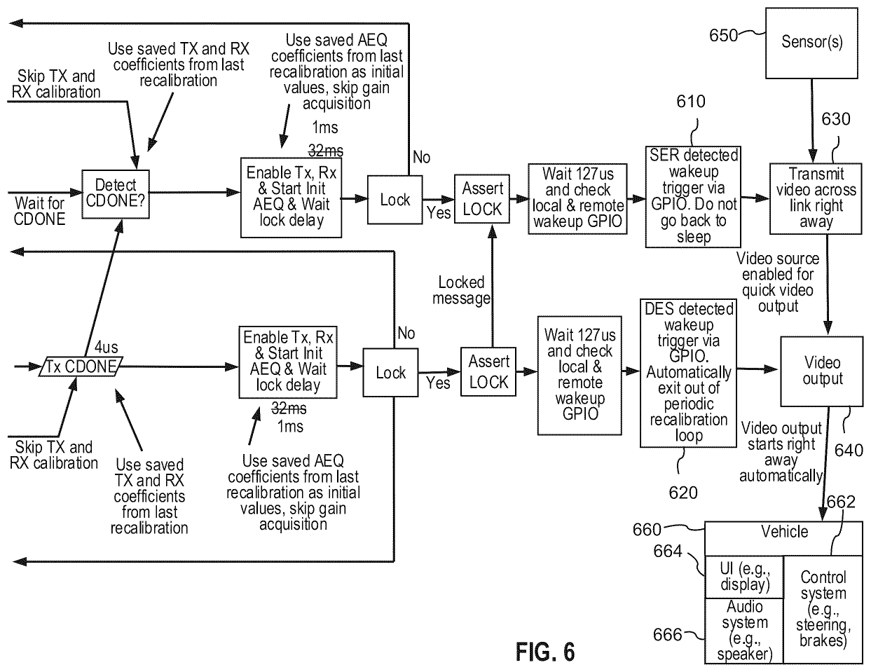

FIG. 6 depicts a portion of final wake of a serializer and a deserializer for data (e.g., video/audio/sensor data) transmission according to one or more aspects. After link lock completion, if the serializer/deserializer detect(s) that a wakeup is triggered via a GPIO, which means the wakeup is for a detected event, rather than for periodic calibration, the serializer/deserializer does not go back to the sleep mode, as indicated a block 610/620. Instead, the serializer turns on and/or otherwise receives and/or accesses data from one or more sensors 650 (e.g., a video camera, an imager, an audio recording device such as a microphone, a movement sensor, and/or a proximity sensor such as radar and/or LiDAR) and transmits data (e.g., video images, audio data, and/or sensor data) via the serial link to the deserializer without delay, as indicated at block 630. Simultaneously, the deserializer starts receiving the data (e.g., video images, audio data, and/or sensor data) via the serial link and outputs the data in a MIPI CSI-2, CSI-3, or other protocol, as indicated at block 640, to the host processor and/or vehicle at block 660 and/or for further processing/use by one or more vehicle systems (e.g., a control system 662 (e.g., steering, brakes, collision avoidance), UI 664 (e.g., one or more displays such as a heads up display and/or imaging display), audio system 666 (e.g., one or more speakers), and/or other vehicle systems).

As described above, in some aspects, the host processor can be configured to determine when an event has concluded and/or when to otherwise go back into a monitoring mode as described in FIGS. 5A-5B and 6. Accordingly, once an event has concluded (e.g., an anticipated collision from another vehicle does not occur, a short monitoring period has ended without any anomalies, a backup event has concluded and a driver or software has switched gears from reverse into drive, or other monitored events) the system and/or method can return to a monitoring mode.

In some aspects, the entire process of FIGS. 5A-5B and 6 without calibration requirements can take about 5 ms. Accordingly, this entire process is more streamlined and faster than known processes, which may take 70-80 ms or even 100 ms.

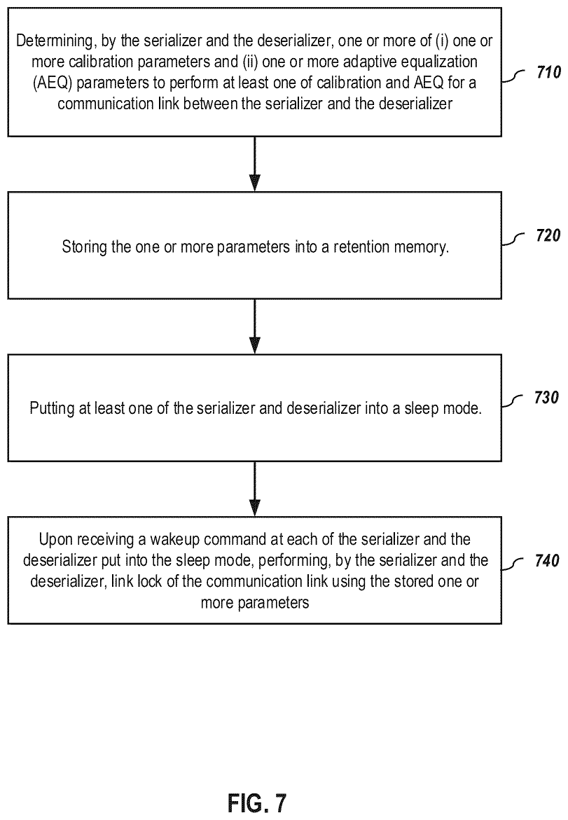

FIG. 7 is a flow diagram illustrating methods 700 for managing serial communication between a serializer and a deserializer, according to one or more aspects of the technology disclosed herein. In such methods, a serializer 102 and a deserializer 110 are in a communication architecture, such as the architecture of FIG. 1. The serializer 102 and deserializer 110 determine one or more of (i) one or more calibration parameters and (ii) one or more adaptive equalization (AEQ) parameters to perform at least one of calibration and AEQ for a communication link between the serializer and the deserializer-Block 710. In a continuing example, the serializer 102 and deserializer 110 operate as described in conjunction with FIG. 4A and FIG. 4B to obtain calibration and equalization parameters of the communications link. In the continuing example, there is no system event, e.g., a sensor trigger, other event at the system level, which prompts the calibration and equalization. The process of Block 710 is performed to determine the calibration and equalization parameters for subsequent use in communication without the lag associated with the calibration and equalization process.

The parameters are then stored in retention memory-Block 720. In the continuing example, the serializer 102 locally stores the determined calibration and equalization parameters corresponding to the serializer 102 in retention memory on the serializer 102. Similarly, the deserializer 110 locally stores the determined calibration and equalization parameters corresponding to the deserializer 110 in retention memory on the deserializer 110. As noted above, retention memory is memory that persists when the device corresponding to the parameters is placed in a sleep/low power mode. Examples include [1] non-volatile memory on the device corresponding to the parameters, [2] volatile memory that remains powered on the device corresponding to the parameters when the device is in sleep/low power mode, [3] memory off the device corresponding to the parameters that persists when the device corresponding to the parameters when the device is in sleep/low power mode.

In some examples, both the serializer 102 calibration and equalization parameters and the deserializer 110 calibration and equalization parameters are stored in memory the deserializer 110, which remains awake and hence persistent/retained. In some examples, the parameters for both devices are stored elsewhere, e.g., memory powered (persistent/retained) away from the devices but accessible to the devices by direct memory access.

One or both of the serializer 102 and deserializer 110 are put into a sleep/low power mode-Block 730. In the continuing example, the deserializer 110 remains powered and commands the serializer 102 to sleep/low power mode.

Upon receiving a wakeup command at each of the serializer and the deserializer put into the sleep mode, the serializer and the deserializer perform link lock of the communication link using the stored one or more parameters-Block 740. In the continuing example, only the serializer 102 was put into sleep/low power mode. A sensor 202 interrupt wakes the serializer 102. The serializer 102 uses the calibration and equalization parameters stored as described in connection with Block 720 to move directly to link lock with the deserializer 110. Likewise, the deserializer 110 moves directly to link lock with the serializer using the deserializer calibration and equalization parameters stored thereon as described in connection with Block 720.

In some examples, the determining, the storing, and the putting into a sleep mode are periodically performed by temporarily waking up each sleeping serializer and sleeping deserializer from a sleep mode for each of the determining, the storing, and the putting into a sleep mode.

In some examples, a serializer and deserializer are coupled via a serial link, which may be a GMSL, GMSL-2, or GMSL-3 link. At least one calibration of the serial link is performed to calibrate one or more parameters of a serializer Tx/Rx, a deserializer Tx/Rx, a serializer AEQ, and/or a deserializer AEQ. The at least one calibration of the serial link may be periodic calibrations performed in a periodic cycle by temporarily waking up the serializer from a low power state (or a sleep mode) for each calibration. In some aspects, nonperiodic calibrations can occur or be triggered, such as by a change in ambient temperature (e.g., air around chip), external voltage, or other external operating condition(s). Accordingly, one or more sensors (e.g., temperature sensor, voltage detector, or other ambient environmental sensors) and/or logic can be employed to determine if a change in condition(s) occurs and decide if a calibration/recalibration is required based on specific configuration(s) of a particular implementation.

In some such examples, the one or more parameters during each calibration are stored in a memory and overwritten parameters previously stored in the memory. In such examples, upon completion of each calibration, the serializer is put back into the low power state.

In some such examples, upon receiving a wake command for the serializer, the stored one or more parameters are used directly to initiate a link lock for serial communication between the serializer and the deserializer. By doing so, one or more calibrations of the serializer or the deserializer may be skipped to enable a fast link lock. If the stored one or more parameters are adequate to complete a link lock, the process proceeds to data (e.g., video images, audio data, and/or sensor data) transmission from the serializer to the deserializer via the serial link. Otherwise, the process goes back to a PHY reset for a new round of calibration until the link lock is complete.

Aspects of the present disclosure may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that aspects of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Aspects of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

Some further example aspects of the systems and methods described herein are provided in the following clauses.

In Example 1, the technology described herein relates to a method for managing serial communication between a serializer and a deserializer, including: determining, by the serializer and the deserializer, one or more of (i) one or more calibration parameters and (ii) one or more adaptive equalization (AEQ) parameters to perform at least one of calibration and AEQ for a communication link between the serializer and the deserializer; storing the one or more parameters into a retention memory; putting at least one of the serializer and deserializer into a sleep mode; and upon receiving a wakeup command at each of the serializer and the deserializer put into the sleep mode, performing, by the serializer and the deserializer, link lock of the communication link using the stored one or more parameters.

In Example 2, in addition to the features of Example 1, the technology described relates to a method, wherein the determining, the storing, and the putting into a sleep mode are periodically performed by temporarily waking up each sleeping serializer and sleeping deserializer from a sleep mode for each of the determining, the storing, and the putting into a sleep mode. In Example 3, in addition to the features of any one or more prior examples, the technology described relates to a method, wherein the communication link is a Gigabit Multimedia Serial Link (GMSL), a GMSL-2, or a GMSL-3 link that supports multimedia serial communication. In Example 4, in addition to the features of any one or more prior examples, the technology described relates to a method, wherein the determined parameters include one or more of: one or more parameters of a serializer transmitter (Tx); one or more parameters of a serializer receiver (Rx); one or more parameters of a deserializer Tx; one or more parameters of a deserializer Rx; one or more parameters of a serializer adaptive equalizer (AEQ); or one or more parameters of a deserializer AEQ. In Example 5, in addition to the features of any one or more prior examples, the technology described relates to a method, wherein the determined parameters include one or more of temperature or external voltage. In Example 6, in addition to the features of any one or more prior examples, the technology described relates to a method, wherein the determined parameters include one or more of capacitance, receiver gain, or adaptation coefficients. In Example 7, in addition to the features of any one or more prior examples, the technology described relates to a method, wherein during a current calibration, the one or more calibration parameters are saved into the retention memory to overwrite calibration parameters saved during a previous calibration. In Example 8, in addition to the features of any one or more prior examples, the technology described relates to a method, wherein a signal from a sensor causes the wakeup command to be transmitted and the sensor includes one or more of an imaging sensor, an audio sensor, a radar detector, or a LiDAR detector. In Example 9, in addition to the features of any one or more prior examples, the technology described relates to a method, wherein a signal from a host processor causes the wakeup command to be transmitted. In Example 10, in addition to the features of any one or more prior examples, the technology described relates to a method, wherein the wakeup command is transmitted based on a timing threshold being met.

In Example 11, the technology described herein relates to a system for managing serial communication, including: a serializer including at least one processor; a deserializer including at least one processor; a communication link connecting the serializer and deserializer; retention memory; and program memory including instructions that when executed by processors of the system are operative to cause the system to: determine, for each of the serializer and the deserializer, one or more of (i) one or more calibration parameters and (ii) one or more adaptive equalization (AEQ) parameters to perform at least one of calibration and AEQ for the communication link; store the one or more parameters into the retention memory; put at least one of the serializer and deserializer into a sleep mode; and upon receiving a wakeup command at each of the serializer and the deserializer put into the sleep mode, performing, by the serializer and the deserializer, link lock of the communication link using the stored one or more parameters.

In Example 12, in addition to the features of Example 11, the technology described relates to a system, wherein the determining, the storing, and the putting into a sleep mode are periodically performed by temporarily waking up each sleeping serializer and sleeping deserializer from a sleep mode for each of the determining, the storing, and the putting into a sleep mode. In Example 13, in addition to the features of Example 11 and Example 12, the technology described relates to a system, wherein the retention memory storing the one or more parameters for the serializer is part of one of the serializer or the deserializer. In Example 14, in addition to the features of Example 11-Example 13, the technology described relates to a system, wherein the retention memory storing the one or more parameters for the deserializer is part of one of the serializer or the deserializer.

In Example 15, in addition to the features of Example 11-Example 14, the technology described relates to a system, wherein the communication link is a Gigabit Multimedia Serial Link (GMSL), a GMSL-2, or a GMSL-3 link that supports multimedia serial communication. In Example 16, in addition to the features of Example 11-Example 15, the technology described relates to a system, wherein the determined parameters include one or more of: one or more parameters of a serializer transmitter (Tx); one or more parameters of a serializer receiver (Rx); one or more parameters of a deserializer Tx; one or more parameters of a deserializer Rx; one or more parameters of a serializer adaptive equalizer (AEQ); or one or more parameters of a deserializer AEQ. In Example 17, in addition to the features of Example 11-Example 16, the technology described relates to a system, wherein the determined parameters include one or more of temperature or external voltage. In Example 18, in addition to the features of Example 11-Example 17, the technology described relates to a system, wherein the determined parameters include one or more of capacitance, receiver gain, or adaptation coefficients. In Example 19, in addition to the features of Example 11-Example 18, the technology described relates to a system, wherein during a current calibration, the one or more calibration parameters are saved into the retention memory to overwrite calibration parameters saved during a previous calibration. In Example 20, in addition to the features of Example 11-Example 19, the technology described relates to a system, wherein a signal from a sensor causes the wakeup command to be transmitted and the sensor comprises one or more of an imaging sensor, an audio sensor, a radar detector, or a LiDAR detector.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and aspects are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure.

What is claimed is:

1. A method for managing serial communication between a serializer and a deserializer, comprising:
determining, by the serializer and the deserializer, one or more of (i) one or more calibration parameters and (ii) one or more adaptive equalization (AEQ) parameters to perform at least one of calibration and AEQ for a communication link between the serializer and the deserializer;
storing the one or more parameters into a retention memory;
putting at least one of the serializer and deserializer into a sleep mode; and
upon receiving a wakeup command at each of the serializer and the deserializer put into the sleep mode, performing, by the serializer and the deserializer, link lock of the communication link using the stored one or more parameters.

2. The method of claim 1, wherein the determining, the storing, and the putting into a sleep mode are periodically performed by temporarily waking up each sleeping serializer and sleeping deserializer from a sleep mode for each of the determining, the storing, and the putting into a sleep mode.

3. The method of claim 1, wherein the communication link is a Gigabit Multimedia Serial Link (GMSL), a GMSL-2, or a GMSL-3 link that supports multimedia serial communication.

4. The method of claim 1, wherein the determined parameters comprise one or more of: one or more parameters of a serializer transmitter (Tx); one or more parameters of a serializer receiver (Rx); one or more parameters of a deserializer Tx; one or more parameters of a deserializer Rx; one or more parameters of a serializer adaptive equalizer (AEQ); or one or more parameters of a deserializer AEQ.

5. The method of claim 1, wherein the determined parameters comprise one or more of temperature or external voltage.

6. The method of claim 1, wherein the determined parameters comprise one or more of capacitance, receiver gain, or adaptation coefficients.

7. The method of claim 1, wherein during a current calibration, the one or more calibration parameters are saved into the retention memory to overwrite calibration parameters saved during a previous calibration.

8. The method of claim 1, wherein a signal from a sensor causes the wakeup command to be transmitted and the sensor comprises one or more of an imaging sensor, an audio sensor, a radar detector, or a LiDAR detector.

9. The method of claim 1, wherein a signal from a host processor causes the wakeup command to be transmitted.

10. The method of claim 1, wherein the wakeup command is transmitted based on a timing threshold being met.

11. A system for managing serial communication, comprising:
a serializer comprising at least one processor;
a deserializer comprising at least one processor;
a communication link connecting the serializer and deserializer;
retention memory; and
program memory comprising instructions that when executed by processors of the system are operative to cause the system to:
determine, for each of the serializer and the deserializer, one or more of (i) one or more calibration parameters and (ii) one or more adaptive equalization (AEQ) parameters to perform at least one of calibration and AEQ for the communication link;
store the one or more parameters into the retention memory;
put at least one of the serializer and deserializer into a sleep mode; and
upon receiving a wakeup command at each of the serializer and the deserializer put into the sleep mode, performing, by the serializer and the deserializer, link lock of the communication link using the stored one or more parameters.

12. The system of claim 11, wherein the determining, the storing, and the putting into a sleep mode are periodically performed by temporarily waking up each sleeping serializer and sleeping deserializer from a sleep mode for each of the determining, the storing, and the putting into a sleep mode.

13. The system of claim 11, wherein the retention memory storing the one or more parameters for the serializer is part of one of the serializer or the deserializer.

14. The system of claim 11, wherein the retention memory storing the one or more parameters for the deserializer is part of one of the serializer or the deserializer.

15. The system of claim 11, wherein the communication link is a Gigabit Multimedia Serial Link (GMSL), a GMSL-2, or a GMSL-3 link that supports multimedia serial communication.

16. The system of claim 11, wherein the determined parameters comprise one or more of: one or more parameters of a serializer transmitter (Tx); one or more parameters of a serializer receiver (Rx); one or more parameters of a deserializer Tx; one or more parameters of a deserializer Rx; one or more parameters of a serializer adaptive equalizer (AEQ); or one or more parameters of a deserializer AEQ.

17. The system of claim 11, wherein the determined parameters comprise one or more of temperature or external voltage.

18. The system of claim 11, wherein the determined parameters comprise one or more of capacitance, receiver gain, or adaptation coefficients.

19. The system of claim 11, wherein during a current calibration, the one or more calibration parameters are saved into the retention memory to overwrite calibration parameters saved during a previous calibration.

20. The system of claim 11, wherein a signal from a sensor causes the wakeup command to be transmitted and the sensor comprises one or more of an imaging sensor, an audio sensor, a radar detector, or a LiDAR detector.
